(19) United States
(12) Patent Application Publication
(10) Pub. No.: US 2024/0391810 A1
(43) Pub. Date: Nov. 28, 2024

(54) PRESSURE-FREE MEMBRANE-TYPE OXYGEN PERMEATION BIOFILM REACTOR DRIVEN BY SEWAGE THERMAL ENERGY AND ITS REGULATION METHOD

(71) Applicant: Chongqing University, Chongqing (CN)

(72) Inventors: Yi Chen, Chongqing (CN); Wenbo Nie, Chongqing (CN)

(21) Appl. No.: 18/460,754

(22) Filed: Sep. 5, 2023

(30) Foreign Application Priority Data
May 22, 2023 (CN) 2022115463227

(51) Int. Cl. C02F 3/10

(52) U.S. Cl. CPC C02F 3/102

(57) ABSTRACT

A pressure-free membrane-type oxygen permeation biofilm reactor driven by sewage thermal energy includes an aeration element, the aeration element is internally provided with a nonporous hollow fiber membrane, and two ends of the nonporous hollow fiber membrane are connected to a cold air chamber and a hot air chamber respectively. A temperature difference is formed between the cold air chamber and the hot air chamber, which can promote air flow inside the membrane and promote mass transfer of oxygen within a biofilm. A problem that energy consumption of sewage purification is unable to compensate due to a low thermal energy grade in sewage can be solved. A high efficiency of oxygen mass transfer is realized, stable functional zones of the biofilm are divided, and a sewage purification efficiency is improved. Dissolved methane can be used as an internal carbon source generated by anaerobic digestion to reduce nitrite in sewage.

### TECHNICAL FIELD

The disclosure relates to a field of biological treatments of sewage, in particular to a novel sewage reoxygenation technology and its regulation method, belonging to the field of sewage treatment technologies.

### BACKGROUND

With rapid development of economy and advancement of urbanization, a scale of sewage treatment in China has exceeded 200 million tons per day in 2022, total carbon emissions of the sewage treatment industry account for about 3% of total social carbon emissions, and it is an undeniable source of carbon emissions. Under strategic requirements of energy conservation, emission reduction, and carbon peaking in the fourteenth five-year plan of China, it is an important strategy to save energy, reduce consumption, improve energy utilization rate and find alternative energy sources to realize the synergy of pollution reduction and carbon reduction and global sustainable development.

At present, the sewage treatment is mainly based on a biochemical technology, using energy input and utilizing microbial metabolic functions to achieve decomposition or conversion of pollutants, thereby achieving sewage discharge standards. Taking an analysis of power energy consumption as an example, electricity costs of traditional sewage treatment plants account for over 30% of total operating costs, with aeration energy consumption accounting for about 50%-70%. Secondly, the treatment process of anaerobic methane recovery using carbon diversion in sewage (such as the Strass sewage treatment plant in Austria and the Yixing new concept sewage treatment plant in China) implements the concept of sustainable sewage treatment, but some methane is blown off in a form of dissolved state in a subsequent traditional aeration nitrification process, and enters an atmospheric environment, causing secondary emissions of the methane. Based on above analysis, traditional aeration methods face two major challenges: high energy consumption and easy blowing off of dissolved methane, which is not conducive to achieving a current goal of “carbon neutrality” in the sewage treatment. Therefore, exploring a new type of sewage aeration methods is particularly crucial for sustainable sewage treatment.

From a perspective of energy consumption, traditional sewage treatment plants are energy consuming plants. However, potential energy contained in urban sewage (including 90% thermal energy and 10% chemical energy) can reach 9-10 times of the energy consumption of the sewage treatment. Therefore, if the sewage thermal energy and chemical energy are extracted and used for sewage purification, transformation from sewage treatment energy consumption plant to energy plant can be realized theoretically. However, only 10% of the chemical energy is not enough to turn the sewage treatment plant into the energy plant. It should be emphasized that even if kitchen waste is introduced into the anaerobic digestion system to turn the sewage treatment plant into the energy plant (such as the Yixing new concept sewage treatment plant in China), the kitchen waste is still an external input of energy to the sewage treatment plant and should not be included in energy balance of the sewage treatment plant. Therefore, from an energy perspective, recovering thermal energy from sewage is particularly important for achieving the carbon neutrality in the sewage treatment.

For potential utilization of the thermal energy in sewage, taking conventional urban sewage as an example, temperature of the conventional urban sewage is generally not lower than 15° C. in winter and around 20° C. in summer, which is warm in winter and cool in summer compared to an ambient temperature. If the water source heat pump technology is used, the energy generated for every 1° C. decrease in the sewage temperature can reach 0.26 kilowatts per hour (kW/h) (measured in electrical energy equivalent). Therefore, a water source heat pump technology can be used to recover hot/cold energy from the sewage. However, due to a low grade of thermal energy in the sewage, it is difficult to directly utilize the thermal energy to generate electricity, and the thermal energy exists in a form of cold/heat sources, mainly used for building heating and air conditioning. In addition, the sewage treatment plants are generally facing away from residential areas, resulting in lower actual utilization efficiency. Therefore, breaking through the utilization efficiency of the cold/heat sources is a “bottleneck” technological link in achieving a transformation from a sewage treatment energy consumption plant to an energy processing plant.

### SUMMARY

In order to solve problems existing in the background, a purpose of the disclosure is to provide a low energy consumption, low-carbon emission aeration method driven by sewage thermal energy, especially an active oxygen permeation regulation method for biofilms.

A core of a new aeration element is a membrane oxygenator (see FIG. 1A), which is different from a bubbleless aeration method of hollow fiber membranes and relies on an active diffusion process of the atmospheric air in a cavity of a nonporous hollow fiber membrane through a concentration difference, belonging to an oxygen permeation process; and the membrane oxygenator does not depend on a pressure difference between the high-pressure air in the cavity of the nonporous hollow fiber membrane and the liquid phase partial pressure. Specifically, the oxygen permeation process is coupled with the biofilm to achieve active oxygen permeation through the biofilm. Under a condition that aerobic microorganisms in the biofilm have electron donors (such as ammonia nitrogen and dissolved methane) in the sewage, a capture of oxygen by the aerobic microorganisms in the biofilm is more conducive to the formation of oxygen concentration gradients, thereby promoting an active diffusion of oxygen (see FIG. 2).

A regulation method of the new aeration technology is based on a principle of “thermal sedimentation of atmosphere”, which specifically relates to temperature difference regulation of air flow, thereby to regulate active oxygen permeation of the biofilms. Details are as follows: two air chambers, namely a cold air chamber and a hot air chamber, are disposed at two ends of the aeration element. The reactor is provided with a nonporous hollow fiber membrane therein, the nonporous hollow fiber membrane is connected to the cold air chamber and hot air chamber at two ends. There is a temperature difference between the two air chambers, which can promote air flow within the membrane and promote mass transfer of oxygen within the biofilm, as shown in FIG. 3. The above device is applied to the biofilm sewage denitrification system, which can achieve stable layering of the biofilm, and different functional zones (aerobic, anoxic, and anaerobic zones) are stable and significant. By adjusting the temperature difference between the cold air chamber and the hot air chamber to 2° C., 5° C., 10° C., and 20° C., the migration of the functional zones of the biofilm along a depth direction of the biofilm can be adjusted (see FIG. 4), thereby regulating a purification performance of the sewage.

A temperature difference regulation biofilm oxygen permeation technology is applied to the sewage treatment process, which can be coupled with a sewage source heat pump technology and a water quality purification technology to realize in-situ purification utilization of extracted sewage thermal energy, that is, sewage thermal energy self-driven biofilm oxygen permeation regulation sewage purification process (see FIG. 5). During an operation of a sewage thermal energy self-driven biofilm oxygen permeation regulation reactor, when an ambient temperature is low in winter, a hot water flow generated through a heat exchange of the water source heat pump compensates the temperature for the air chamber at an end of the reactor in a form of water bath, causing a temperature of the internal air to be higher than the ambient temperature, thereby forming a temperature difference with the air chamber at another end of the reactor; namely, creating a hot air chamber at an end and a cold air chamber at another end (see FIG. 6). As the temperature of the hot air chamber increases, the air expands, resulting in a decrease in the air pressure inside the hot air chamber of the reactor, forming a pressure difference with the air inside the cold air chamber of the reactor. The pressure difference is formed by the nonporous hollow fiber membrane connected to the hot air chamber and cold air chamber at two ends, which promotes the air flow inside the nonporous hollow fiber membrane chamber and further promotes mass transfer of oxygen. There is a corresponding relationship among the temperature difference in the air chamber, the air flow rate in the membrane chamber, the oxygen transfer rate of the membrane, and the functional zones of the biofilm. The functional zones of the biofilm can be adjusted by adjusting the temperature difference in the air chamber. Similarly, when the ambient temperature is high in summer, the air chamber connected to the water source heat pump becomes a cold air chamber (see FIG. 6), and the functional zones of the biofilm is adjusted using the same principle.

In the disclosure, a pressure-free membrane-type oxygen permeation biofilm reactor driven by sewage thermal energy includes an aeration element. The aeration element includes a body, upper and lower ends of the body are respectively defined with two air chambers, i.e., a cold air chamber and a hot air chamber, a lower end of the hot air chamber is defined with an air inlet, an upper end of the cold air chamber is defined with an air outlet, an outer side of the hot air chamber is defined with a water bath sleeve, a side wall of the water bath sleeve is defined with a water inlet and a water outlet opposite to each other, and the water bath sleeve is provided with thermal energy by sewage;

the body is provided with nonporous hollow fiber membrane bundles therein, and each of the nonporous hollow fiber membrane bundles are connected to the cold air chamber and the hot air chamber at two ends respectively;

a lower end of a side wall of the body is defined with a water inlet, an upper end of the side wall of the body is defined with a water outlet, the water inlet and the water outlet of the body are opposite to each other; and the water inlet of the body and the water outlet of the water bath sleeve are disposed on a same side; and

each of the nonporous hollow fiber membrane bundles is hung with a biofilm.

In an embodiment, each of the nonporous hollow fiber membrane bundles enriches and grows biofilms of aerobic, anoxic and anaerobic microorganisms from inside to outside.

In an embodiment, a thickness of the biofilm is 1500 micron (μm)-2000 μm.

In an embodiment, the nonporous hollow fiber membrane bundles are uniformly arranged.

A sewage thermal energy self-driven biofilm oxygen permeation regulation sewage purification system includes at least one pressure-free membrane-type oxygen permeation biofilm reactor as described above.

In an embodiment, the sewage thermal energy self-driven biofilm oxygen permeation regulation sewage purification system includes two or more pressure-free membrane-type oxygen permeation biofilm reactors connected in series, that is, in the two adjacent reactors, the water outlet of the body of one reactor is connected to the water inlet of the other reactor, and the water inlet of the water bath sleeve of one reactor is connected to the water outlet of the water bath sleeve of the other reactor.

In an embodiment, the sewage thermal energy self-driven biofilm oxygen permeation regulation sewage purification system further includes a water source heat pump intake pool, a water source heat pump heat exchange group, and water circulation pumps; a water outlet of the water source heat pump heat exchanger group is connected to the water inlet of the water bath sleeve through the water circulation pump, the water outlet of the water bath sleeve is connected to a water inlet of the water source heat pump heat exchange group, a top water outlet of the water source heat pump water intake pool is connected to another water inlet of the water source heat pump heat exchange group, another water outlet of the water source heat pump heat exchanger group is connected to a water inlet of a lower part of the water source heat pump water intake pool through the water circulation pump, and the water outlet of the body is connected to a top water inlet of the water source heat pump intake pool.

Compared with traditional aeration oxygen supply methods, the oxygen permeation method of extracting self-driven air flow through sewage thermal energy is more advantageous, which is reflected in the following three points.

(1) Low energy consumption operation helps sewage treatment plants achieve energy self-sufficiency.

Effluent of urban sewage plants contains rich low-grade thermal energy, which has great development and utilization value as cold and heat sources for heat pumps. However, existing forms of utilization of the cold and heat sources are only limited to the use of heating and air conditioning in buildings, which greatly limits the utilization of sewage thermal energy. Based on the above problems, the disclosure innovatively develops the oxygen permeation control technology driven by sewage heat pump, realizes the extraction of sewage thermal energy and the in situ clean water utilization, and opens up a new path of low-carbon sewage purification collaborative capacity. Combining the principle of biomimetic “artificial lung”, the cold and heat sources of sewage source heat pumps are cleverly applied in the sewage purification process, fully utilizing the thermal energy of sewage to reduce the energy consumption of water purification, and achieving “pollution control”. Replacing the use of high-grade energy (electricity, natural gas, etc.) with low-grade energy (sewage thermal energy) can help sewage treatment plants achieve energy self-sufficiency.

(2) Efficient oxygen mass transfer and functional biofilm stable zones improve sewage purification efficiency.

A traditional aeration method first allows oxygen to enter water, and then further reacts with solid-phase microorganisms, resulting in a gas-liquid-solid three-phase mass transfer, a high mass transfer resistance leads to low mass transfer efficiency, which is generally less than about 20%. An aeration method of sewage thermal energy self-driven oxygen permeation biofilm directly transfers oxygen to solid-phase microorganisms, with only gas-solid two-phase mass transfer, which can greatly improve utilization efficiency of the oxygen. By means of active oxygen permeation and substrate counter diffusion, aerobic microorganisms, anoxic microorganisms and anaerobic microorganisms are enriched and grown from inside to outside on the biofilm. Ammonia nitrogen in influent will be oxidized to nitrite and nitrate, and then denitrification can be achieved through anaerobic processes such as anaerobic ammoxidation and denitrification anaerobic oxidation of methane. By adjusting the temperature difference between the cold air chamber and the hot air chamber, promoting air flow and achieving optimal oxygen concentration, removal effect of pollutants in water can be optimized.

(3) Internal carbon source (dissolved methane produced by anaerobic digestion, etc.) during sewage denitrification is fully used.

As shown in FIG. 7, compared to the hollow fiber membrane bubbleless aeration technology, the advantages of biofilm active oxygen permeation technology are mainly reflected in: through active oxygen permeation and substrate anisotropic diffusion, it promotes the stable layering of aerobic biofilm, anoxic biofilm, and anaerobic biofilm, separates the oxidation of ammonia nitrogen and chemical oxygen demand (COD) in sewage in space, and reduces the oxidation of the COD in sewage by oxygen, and the COD is applied as the electron donor to the denitrification process, especially suitable for biological denitrification of sewage with insufficient carbon to nitrogen ratio. Secondly, the active oxygen permeation process can well retain the dissolved methane in the sewage. While controlling methane emission reduction, it further makes up for the deficiency of carbon nitrogen ratio in biological denitrification, and is especially suitable for the application of the newly discovered biological process (denitrifying anaerobic methane oxidation (DAMO)) to sewage denitrification. As the internal carbon source generated by anaerobic digestion, dissolved methane can be used as the electron donor for a reduction of (nitrite) nitrate in sewage to achieve “waste treatment”.

Specifically, a principle of biofilm self-driven oxygen permeation reactor driven by the sewage source heat pump is different from a principle of traditional membrane aeration biofilm reactor. The membrane aeration biofilm reactor improves aeration efficiency through the nonporous hollow fiber membrane and using high-pressure gas in the membrane cavity as the aeration driving force. As shown in FIG. 7, it is difficult to form clear biofilm aerobic zone, anoxic zone, and anaerobic zone during the high-pressure gas aeration process. Oxygen easily penetrates an entire biofilm layer and forms a certain concentration of dissolved oxygen in the sewage, thus the COD is oxidized in the sewage and the lack of denitrification carbon source is exacerbated; and during the aeration process, due to the dissolution of oxygen and the overflow of large bubbles, the dissolved methane in the sewage will pass through gas-liquid interface, transfer to gas phase, and be blown out of the sewage, increasing greenhouse gas emission factor of sewage treatment.

In order to further understand features and technical content of the disclosure, please refer to the following detailed description and accompanying drawings. However, the accompanying drawings are only for reference and explanation purposes and are not intended to limit the disclosure.

### BRIEF DESCRIPTION OF DRAWINGS

FIG. 1A illustrates a schematic diagram of a membrane oxygenator.

FIG. 1B illustrates a schematic diagram of a principle of biofilm oxygen permeation.

FIG. 2 illustrates a conceptual diagram of an application of biofilm oxygen permeation in water quality purification.

FIG. 3 illustrates a schematic diagram of temperature difference regulation of biofilm oxygen permeability.

FIG. 4 illustrates a schematic diagram of experimental results of biofilm functional zones driven by different temperature differences.

FIG. 5 illustrates a schematic diagram of a sewage purification process of sewage thermal energy self-driven biofilm oxygen permeation regulation.

FIG. 6 illustrates a schematic diagram of a coupling structure of a sewage source heat pump and an oxygen permeation biofilm technology.

FIG. 7 illustrates a microscopic mechanism diagram of substrate diffusion inside a self-permeable biofilm driven by sewage thermal energy.

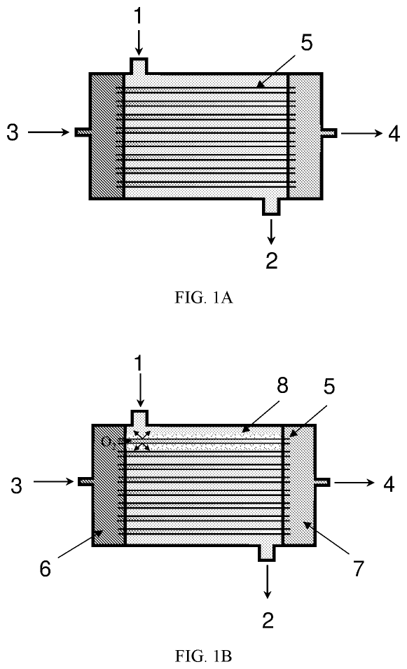

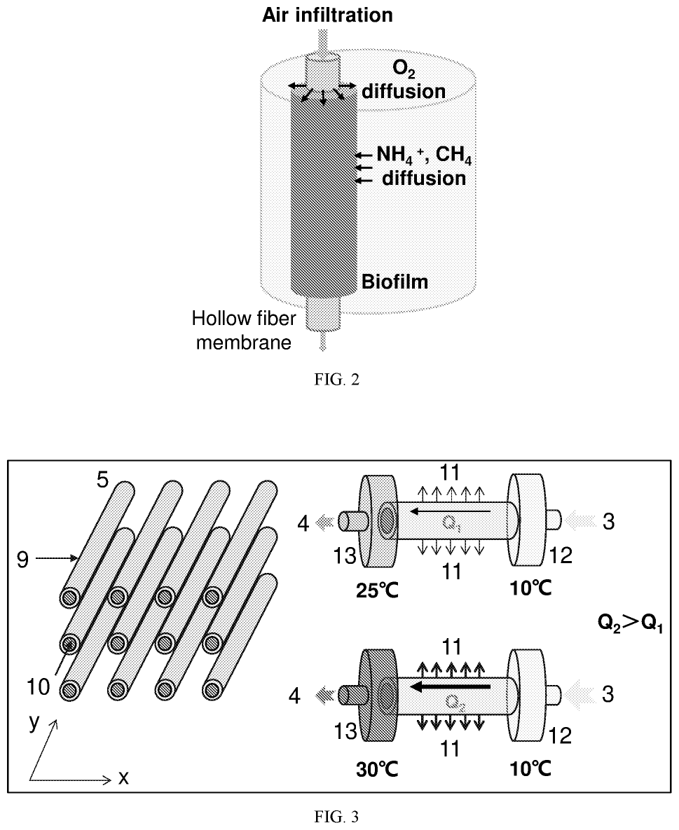

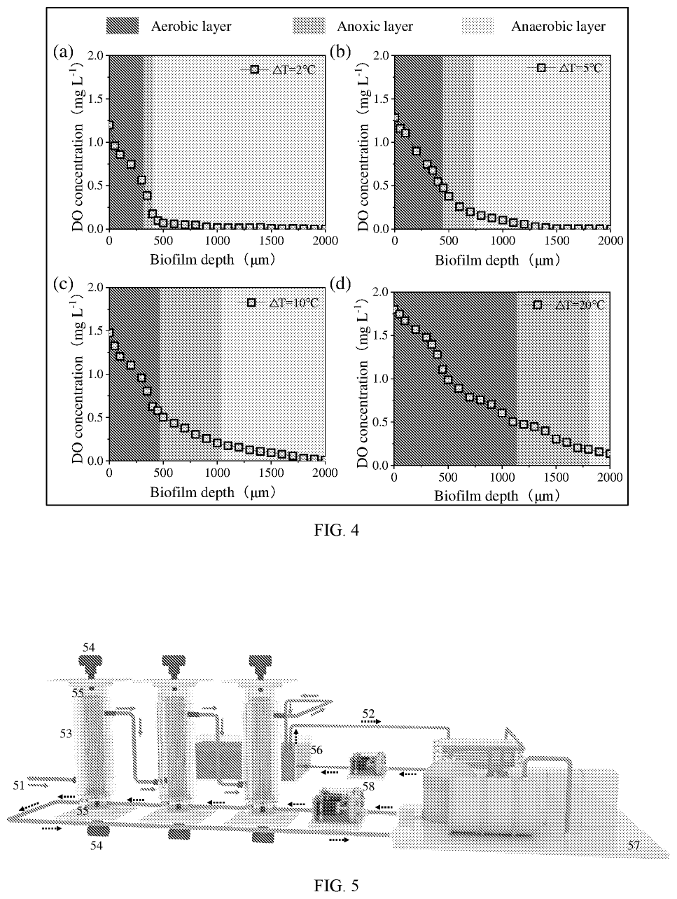

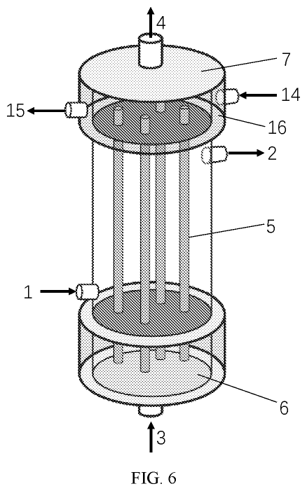

### DESCRIPTION OF REFERENCE NUMERALS

1. reoxygenation solution inlet; 2. reoxygenation solution outlet; 3. air inlet; 4. air outlet; 5. nonporous hollow fiber membrane; 6. air inlet chamber; 7. air outlet chamber; 8. sewage; 9. water flow direction; 10. air flow direction in a membrane cavity; 11. membrane oxygen transfer direction; 12. cold air chamber; 13. hot air chamber; 14. water inlet connected to the sewage source heat pump for heat exchange; 15. water outlet connected to the sewage source heat pump for heat exchange; 16. water bath layer (i.e., water bath sleeve) for compensating the temperature of the air chamber with heat exchange water; 51. sewage flow direction; 52. heat exchange water flow direction; 53. main body of the oxygen permeation biofilm reactor; 54. air inlet/outlet; 55. hot/cold air chamber; 56. water source heat pump intake pool; 57. water source heat pump heat exchange unit; 58. water circulation pump.

### DETAILED DESCRIPTION OF EMBODIMENTS

Based on specific embodiments, the disclosure is further elaborated as follows. It should be understood that the embodiments are only used to illustrate the disclosure and not to limit a scope of the disclosure.

The following specific embodiments are provided for better understanding the disclosure. However, the disclosure is not limited to a description of the specific embodiments.

A pressure-free membrane-type oxygen permeation biofilm reactor driven by sewage thermal energy includes an aeration element. The aeration element includes a body, upper and lower ends of the body are provided with two air chambers, a cold air chamber and a hot air chamber, respectively. A lower end of the hot air chamber is defined with an air inlet, an upper end of the cold air chamber is defined with an air outlet, an outer side of the hot air chamber is defined with a water bath sleeve, a side wall of the water bath sleeve is defined with a water inlet and a water outlet opposite to each other, and the water bath sleeve is provided with thermal energy by sewage. The body is provided with nonporous hollow fiber membrane bundles inside, and each of the nonporous hollow fiber membrane bundles are connected to the cold air chamber and the hot air chamber at two ends respectively. A lower end of the side wall of the body is defined with a water inlet, an upper end of the side wall of the body is defined with a water outlet, the water inlet and the water outlet of the body are opposite to each other. and the water inlet of the body and the water outlet of the water bath sleeve are disposed on the same side. Each of the nonporous hollow fiber membrane bundles is hung with a biofilm.

In an embodiment, the nonporous hollow fiber membrane bundle enriches and grows biofilms of aerobic, anoxic and anaerobic microorganisms from inside to outside.

In an embodiment, the thickness of a layer of the biofilm is 2000 micron (μm).

In an embodiment, the nonporous hollow fiber membrane bundles are uniformly arranged.

A sewage thermal energy self-driven biofilm oxygen permeation regulation sewage purification system includes at least three pressure-free membrane-type oxygen permeation biofilm reactors as described above which are connected in series. In two adjacent reactors, the water outlet of the body of one reactor is connected to the water inlet of the body of the other reactor, and the water inlet of the water bath sleeve of one reactor is connected to the water outlet of the water bath sleeve of the other reactor.

The sewage thermal energy self-driven biofilm oxygen permeation regulation sewage purification system further includes a water source heat pump intake pool, a water source heat pump heat exchange group, and a water circulation pump. A water outlet of the water source heat pump heat exchanger group is connected to the water inlet of the water bath sleeve through the water circulation pump, the water outlet of the water bath sleeve is connected to a water inlet of the water source heat pump heat exchange group, a top water outlet of the water source heat pump water intake pool is connected to a water inlet of the water source heat pump heat exchange group, and a water outlet of the water source heat pump heat exchanger group is connected to a water inlet of a lower part of the water source heat pump water intake pool through the water circulation pump, and a water outlet of the body is connected to a top water inlet of the water source heat pump intake pool.

A pressure difference is formed by each of the nonporous hollow fiber membrane bundles connected to the hot air chamber and the cold air chamber at two ends, which promotes air flow in a cavity of each of the nonporous hollow fiber membrane bundles. The high-pressure gas inside the nonporous hollow fiber membrane bundles serves as an aeration driving force.

Contents of the disclosure can be well aligned with a current sustainable sewage treatment concept, such as an application in an adsorption biodegradation process (AB process). An adsorption section (section A) captures organics from sewage to a greatest extent and converts the organics into energy substance methane through an anaerobic digestion process of settling sludge. A biodegradation section (B section) is mainly used for removal of pollutants and recovery of nutrients. A core of the AB process is to capture as much organics as possible before sewage enters the B section, and store the organics in the form of surplus sludge for energy recycling, which fully reflects the sustainable sewage treatment concept. The sewage source heat pump driven self-permeation biofilm technology can be used in the B section. A specific implementation process is as follows.

During the operation of the AB process, an effluent from the A section enters into the self-permeable oxygen biofilm reactor through the water inlet in FIG. 5. The pollutants in the sewage can be removed through an action of microorganisms enriched on the nonporous hollow fiber membrane (ammoxidation, methane oxidation, (nitrite) nitrate reduction and other processes), and then the effluent can be discharged from the water outlet. And two ends of the nonporous hollow fiber membrane are respectively connected to the cold air chamber and the hot air chamber, and the cold air chamber and the hot air chamber are respectively connected to the air inlet of the reactor and the air outlet of the reactor. By adjusting the temperature difference between the cold air chamber and the hot air chamber, the air flow rate in the cavity of the nonporous hollow fiber membrane is adjusted, the oxygen permeability of the biofilm is further adjusted to control functional zones of the biofilm. Oxygen forms a significant oxygen concentration gradient along the vertical direction of the biofilm, and there are enriched aerobic, anoxic and anaerobic microorganisms on the biofilm from inside to outside.

In order to fully utilize cold and heat sources exchanged by sewage source heat pumps, the cold air chamber and the hot air chamber of the reactor undergo changes in different seasons. Taking typical summer and winter as examples, in winter, when a sewage temperature is higher than an ambient temperature, a hot water flow with a temperature higher than the ambient temperature is obtained through the heat exchange of a sewage source heat pump. The hot water flow compensates the temperature of the air chamber connected to the sewage source heat pump through a water bath, causing the air temperature in the air chamber to be higher than the ambient temperature, becoming a hot air chamber, and an air hole connected to the hot air chamber becomes the outlet hole of the reactor. The air chamber that is consistent with the ambient temperature becomes the cold air chamber, and the air hole connected to the cold air chamber becomes the inlet hole of the reactor. Similarly, in summer, when the temperature of sewage is lower than the ambient temperature, a cold water flow with a temperature lower than the ambient temperature is obtained through the exchange of the sewage source heat pump. The cold water flow decreases the temperature of the air chamber connected to the sewage source heat pump through a water bath, causing the air temperature of the air chamber to be lower than the ambient temperature, forming a cold air chamber, and the air hole connected to the cold air chamber becomes the inlet hole of the reactor. The air chamber that is consistent with the ambient temperature becomes the hot air chamber, and the air hole connected to the hot air chamber becomes the air outlet of the reactor.

By adjusting the temperature difference between the cold air chamber and the hot air chamber, the air flow inside the nonporous hollow fiber membrane is adjusted, thereby regulating the oxygen permeability of the biofilm and controlling aerobic, anoxic, and anaerobic functional zones of the biofilm. The efficient removal of pollutants is achieved by adjusting the temperature difference between the cold air chamber and the hot air chamber. The aeration regulation method is simple, easy to operate, and has no energy consumption.

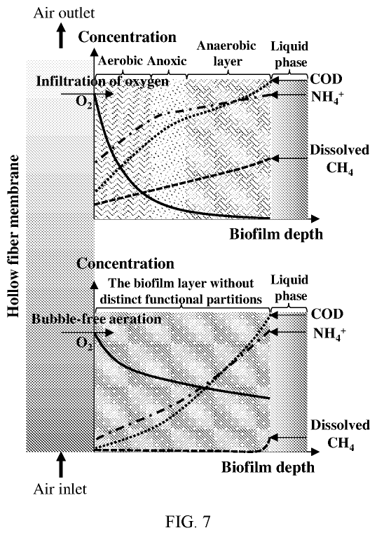

A stable division of the aerobic, anoxic, and anaerobic functional zones of the biofilm on the nonporous hollow fiber membrane is promoted through active oxygen permeation and opposite diffusion of the substrate. As shown in FIG. 7, the oxygen permeates through the nonporous hollow fiber membrane, and the ammonia nitrogen in the sewage diffuses into the anaerobic layer first. In a presence of nitrous acid salts, a small amount of ammonia nitrogen is removed through Anammox and other processes, while more ammonia nitrogen is oxidized and removed through nitration in the aerobic layer. Residual chemical oxygen demand (COD) in sewage is mainly used as a carbon source material in the anaerobic layer for denitrification, while a small portion of the COD enters the aerobic layer for oxidation. By stable division of biofilm functions, precise regulation of sewage carbon source can be achieved, and the COD in sewage can be better utilized to provide electron donors for denitrification processes, reducing its oxidation by oxygen. Meanwhile, due to the oxygen permeation process, a large amount of dissolved methane generated by anaerobic digestion of the A section is retained in the sewage. Through uptake of the biofilm and active diffusion of the methane, the methane can be used as the electron donor in the anaerobic layer. Through denitrifying anaerobic methane oxidation (DAMO) and other processes, it can further reduce the (nitrite) nitrate produced during the nitrification process, while achieving greenhouse gas emission reduction, realizing deep denitrification of the sewage.

In particular, due to the active oxygen permeation of the biofilm, anaerobic functional microorganisms (such as anaerobic ammoxidation, anaerobic oxidation of methane and other functional microorganisms) with a long doubling time are coupled with aerobic microorganisms. For example, by coupling the denitrification anaerobic oxidation of the methane process, the Anammox process, the nitrification process and the aerobic methane oxidation process, the dissolved methane is used as the electron donor for denitrification, which can effectively oxidize the dissolved methane in the sewage while realize the denitrification treatment, and reduce the emission reduction of greenhouse gases in the sewage treatment process. Compared with the denitrification anaerobic oxidation of the methane coupled with the Anammox process for sewage nitrogen and carbon removal, the innovation of the disclosure is further mainly reflected in: aerobic methane oxidation bacteria and denitrification anaerobic oxidation of methane microorganisms work together to oxidize dissolved methane; the nitrifying microorganisms (including ammoxidation bacteria and nitrite oxidation bacteria) in the aerobic zone carry out ammonia nitrogen oxidation, and the (nitrite) nitrogen produced can be used by the denitrifying anaerobic oxidation of methane microorganisms for denitrification. Meanwhile, the anaerobic environment is created for denitrifying anaerobic oxidation of methane microorganisms through the metabolism of aerobic methane oxidation bacteria, the ammoxidation bacteria, the nitrite oxidation bacteria and other aerobic microorganisms in the biofilm, breaking a restriction of denitrification anaerobic oxidation of methane process in the actual application of the sewage treatment.

What is claimed is:

1. A pressure-free membrane-type oxygen permeation biofilm reactor driven by sewage thermal energy comprising an aeration element, wherein the aeration element comprises a body, upper and lower ends of the body are respectively provided with a cold air chamber and a hot air chamber, a lower end of the hot air chamber is defined with an air inlet, an upper end of the cold air chamber is defined with an air outlet, an outer side of the hot air chamber is defined with a water bath sleeve, a side wall of the water bath sleeve is defined with a water inlet and a water outlet opposite to each other, and the water bath sleeve is provided with thermal energy by sewage;
wherein the body is provided with nonporous hollow fiber membrane bundles therein, and two ends of each of the nonporous hollow fiber membrane bundles are connected to the cold air chamber and the hot air chamber respectively;
wherein a lower end of a side wall of the body is defined with a water inlet, an upper end of the side wall of the body is defined with a water outlet, the water inlet of the body and the water outlet of the body are opposite to each other; and the water inlet of the body and the water outlet of the water bath sleeve are disposed on a same side; and
wherein each of the nonporous hollow fiber membrane bundles is hung with a biofilm.

2. The reactor as claimed in claim 1, wherein each of the nonporous hollow fiber membrane bundles enriches and grows a biofilm of aerobic microorganisms, a biofilm of anoxic microorganisms and a biofilm of anaerobic microorganisms from inside to outside.

3. The reactor as claimed in claim 1, wherein a thickness of the biofilm is in a range of 1500 micron (μm) to 2000 μm.

4. The reactor as claimed in 1, wherein the nonporous hollow fiber membrane bundles are uniformly arranged.

5. A sewage thermal energy self-driven biofilm oxygen permeation regulation sewage purification system comprising at least one reactor, wherein each of the at least one reactor is the reactor as claimed in claim 1.

6. The system as claimed in claim 5, wherein the system comprises two or more reactors are connected in series, and each of the two or more reactor is the reactor as claimed in claim 1; in two adjacent reactors of the two or more reactors, the water outlet of the body of one of the two adjacent reactors is connected to the water inlet of the body of the other reactor, and the water inlet of the water bath sleeve of the one reactor is connected to the water outlet of the water bath sleeve of the other reactor.

7. The system as claimed in claim 5, wherein the system further comprises: a water source heat pump intake pool, a water source heat pump heat exchange group, and water circulation pumps; wherein a water outlet of the water source heat pump heat exchanger group is connected to the water inlet of the water bath sleeve through one of the water circulation pumps, the water outlet of the water bath sleeve is connected to a water inlet of the water source heat pump heat exchange group, a top water outlet of the water source heat pump water intake pool is connected to another water inlet of the water source heat pump heat exchange group, another water outlet of the water source heat pump heat exchanger group is connected to a water inlet of a lower part of the water source heat pump water intake pool through another one of the water circulation pumps, and the water outlet of the body is connected to a top water inlet of the water source heat pump intake pool.

8. A purification method of the system as claimed in claim 5, comprising:
forming a pressure difference in each of the nonporous hollow fiber membrane bundles connected to the hot air chamber and the cold air chamber at two ends; and
promoting air flow in a cavity of each of the nonporous hollow fiber membrane bundles according to the pressure difference; wherein a difference from traditional bubble free aeration methods of hollow fiber membranes is that a high-pressure gas in the cavity of the nonporous hollow fiber membrane bundle is not required as an aeration driving force.
